(19) United States
(12) Patent Application Publication
(10) Pub. No.: US 2005/0044421 A1
(43) Pub. Date: Feb. 24, 2005

(54) Computer, control method thereof and a network system

(75) Inventor: Hong-Jin Cho, Seoul City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/919,363

(22) Filed: Aug. 17, 2004

(30) Foreign Application Priority Data
Dec. 22, 2003 (KR) 2003-94609
Aug. 18, 2003 (KR) 2003-56888

(51) Int. Cl. H04L 9/00

(52) U.S. Cl. 713/201

(57) ABSTRACT

A computer connected to a network, including a network part to process data received through the network; and a controller to detect environment identification data from the data received through the network, and to change an operating state of a system into a predetermined operating state corresponding to the detected environment identification data. Accordingly a computer, a control method thereof, and a network system is provided to automatically control an operation of the system, for convenience of a user, in accordance with the environment where a computer is in use by changing the operation of the system into the predetermined operation according to the detected environment identification data when the environment identification data received through the network is detected.

### CROSS-REFERENCE TO RELATED APPLICATIONS

This application claims the benefit of Korean Patent Application Nos. 2003-94609, filed Dec. 22, 2003, and 2003-56888, filed Aug. 18, 2003, in the Korean Intellectual Property Office, the disclosures of which are incorporated herein by reference.

### BACKGROUND OF THE INVENTION

1. Field of the Invention

The present invention relates to a computer, a control method thereof, and a network system, more particularly, to a computer, a control method thereof, and a network system to change an operating state of a system into a predetermined operating state according to an environment identification data detected through a network.

2. Description of the Related Art

Generally, a computer comprises: a main body formed with a plurality of hardware, such as a main board provided with a central processing unit (CPU), a hard disk drive, a graphic card, a floppy disk drive, and a compact disk drive; a displayer to receive an image signal from the main body and to output an image; and an input part to input a predetermined signal to the main body such as a key board, and a mouse.

Generally, a computer can be categorized into a light small portable computer having a liquid crystal display (LCD) panel of slim-type that can be easily carried by a user, and a desktop computer that is placed on a desk for use. Herein, the portable computer includes a lap-top computer, a personal digital assistant (PDA), a tablet computer, and/or other similar devices.

As portable computers are becoming widely distributed, they provide a wireless network or an additional wired network in a public building such as a library, or an office so that the users of the portable computers can have access to various information through the network. For example, a library is generally installed with an access point to provide the wireless network, or an additional communication port to support the wired network.

A conventional computer provides a function that changes an operating state of the computer system into a particular operating state. For example, a microcomputer installed in the computer identifies a case where the user does not use the computer over a certain period of time, and applies a system management interrupt (SMI) signal to a CPU. Herein, a basic input/output system (BIOS) reduces an operating frequency of the CPU, or shuts power supplied to input/output devices. Such operating state described above is generally referred to as a power saving mode.

In addition, when the user uses the conventional computer in a quiet place, such as a library, the computer provides a low-noise mode, which is an operating state to minimize noise occurring during the operating state of the system. Accordingly, when the user selects the low-noise mode, the BIOS stops an operation of a CPU cooling fan that causes most of the noise during the operation of the system, or limits the number of times the CPU cooling fan is operated. Further, the BIOS outputs the SMI signal to reduce the operating frequency of the CPU to the BIOS in order to lower a temperature of the CPU that causes the CPU cooling fan to operate. However, according to the conventional computer, it is inconvenient for the user to select such a function to change the operation of the system into another particular operation. For example, to select the low-noise mode, the user needs to use a particular button provided to the computer or needs to use a particular program to change the operation of the system in order to select the low-noise mode. The user is further inconvenienced, as the user needs to switch the low-noise mode back to a normal mode when the user leaves the library building.

Further, if the user does not switch the operation of the system into the low-noise mode in such a place like the library building, the noise from the CPU cooling fan can be disruptive to others. On the other hand, if the user does not turn the operation back into the normal mode after utilizing the low-noise mode, the system may be damaged due to heat from the CPU.

Such problems may also occur in a setting outside of a library when the user needs to change the operation of the system to a particular operation in accordance with a particular environment. This inconveniences the user because the user has to change the operation of the system according to an environment.

### SUMMARY OF THE INVENTION

Accordingly, it is an aspect of the present invention to provide a computer, a control method thereof, and a network system to change an operation of a system in accordance with an environment when the computer is used in the particular environment.

The foregoing and/or other aspects of the present invention are achieved by providing a computer connected to a network, comprising: a network part to process data received through the network; and a controller to detect environment identification data from the data received through the network, and to change an operating state of a system into a predetermined operating state corresponding to the detected environment identification data.

Additional aspects and/or advantages of the invention will be set forth in part in the description which follows and, in part, will be obvious from the description, or may be learned by practice of the invention.

According to an aspect of the invention, the computer further comprises a database registered with at least one registration data list, and the controller comprises: an environment identifier to detect whether the environment identification data is received, and to output an environment identification signal corresponding to the detected environment identification data when the detected environment identification data exists in the database; and an operation changer to change the operating state of the system into a predetermined operating state corresponding to the environment identification signal upon receipt of the environment identification signal from the environment identifier.

According to an aspect of the invention, the network part comprises a wireless network part connected to a wireless network to process the wirelessly exchanged data, and the environment identification data is included in a beacon signal transmitted from an access point to which the wireless network part is connected, and received through the wireless network.

According to an aspect of the invention, the environment identification data is included in a service set identifier (SSID) of the beacon signal and transmitted.

According to an aspect of the invention, the environment identifier is a wireless network driver that controls the wireless network part.

According to another aspect of the invention, the network part comprises: a wired network part connected to a wired network to process data exchanged within the wired network, and the environment identification data is transmitted from a server to which the wired network part is connected.

According to an aspect of the invention, the environment identifier is a wired network driver that controls the wired network part.

According to an aspect of the invention, the operation changer comprises: a microcomputer to output a change signal corresponding to the environment identification signal when that the environment identification signal is received from the environment identifier; and a BIOS to reduce an operation frequency of the system when that the change signal is received from the microcomputer.

According to an aspect of the invention, the computer further comprises: a cooling fan to cool the system, wherein the BIOS controls the microcomputer to stop operation of the cooling fan or limit the frequency of the operation of the cooling fan when the change signal is received from the microcomputer.

According to an aspect of the invention, the operation changer comprises: a sound controller to control a sound signal outputted from the system, and to implement a mute function upon receipt of the environment identification signal from the environment identifier.

According to an aspect of the invention, the computer further comprises: a displayer to display an image, and the operation changer comprises a display controller to control a level of brightness of the image displayed on the displayer upon receipt of the environment identification signal from the environment identifier.

According to an aspect of the invention, the display controller controls the displayer to display information on the environment identification data corresponding to the environment identification signal upon receipt of the environment identification signal from the environment identifier.

According to another aspect of the present invention, the above and/or other aspect may be also achieved by providing a network system comprising: a computer comprising a network part to process data received from a network, and a controller to detect environment identification data from the data received through the network and to change an operating state of a system into a predetermined operating state corresponding to the detected environment identification data; and a host connected to the computer through the network to transmit the environment identification data to the computer.

According to an aspect of the invention, the host comprises an access point to which the computer is wirelessly connected.

According to an aspect of the invention, the access point transmits the environment identification data included in a beacon signal.

According to an aspect of the invention, the access point transmits the environment identification data included in a SSID allocated in the beacon signal.

According to an aspect of the invention, the host comprises a server to which the computer is wired.

According to an aspect of the invention, the server transmits the environment identification data corresponding to an Internet Protocol (IP) address of the connected computer to the connected computer when the computer is connected to the server.

According to another aspect of the present invention, the above and/or other aspects may also be achieved by providing a control method of a computer connected to a network, comprising: detecting environment identification data from data received through the network; detecting whether the detected environment identification data exist in a registration data list previously registered; and changing an operation of a system into a predetermined operation corresponding to the detected environment identification data when the detected environment identification data exists in the registration data list.

According to an aspect of the invention, the control method of the computer further comprises connecting the computer to an access point through a wireless network, wherein detecting whether the detected environment identification data exists in the registration data list includes detecting whether the environment identification data received from the access point to which the computer is connected exists in the registration data list.

According to an aspect of the invention, the environment identification data is received with a beacon signal transmitted from the access point.

According to an aspect of the invention, the environment identification data is transmitted with in a SSID allocated in the beacon signal.

According to an aspect of the invention, the control method of the computer further comprises connecting the computer to the server through a wired network, wherein detecting whether the detected environment identification data exists in the registration data list comprises detecting whether the environment identification data received from the server to which the computer is connected exists in the registration data list.

According to an aspect of the invention, changing the operation of the system into the predetermined operation corresponding to the detected environment identification data comprises reducing an operating frequency of the system.

According to an aspect of the invention, changing the operation of the system into the predetermined operation corresponding to the detected environment identification data comprises stopping operation of a cooling fan cooling the system or limiting the frequency of the operation of the cooling fan.

According to an aspect of the invention, changing the operation of the system into the predetermined operation corresponding to the detected environment identification data comprises implementing a mute function to limit sound outputted from the system.

According to an aspect of the invention, changing the operation of the system into the predetermined operation corresponding to the detected environment identification data comprises changing a level of brightness of an image displayed on a displayer that displays the image.

According to an aspect of the invention, the control method of the computer further comprises displaying information of the detected environment identification data on the displayer when the detected environment identification data exists in the registration data list.

### BRIEF DESCRIPTION OF THE DRAWINGS

These and/or other aspects and advantages of the invention will become apparent and more readily appreciated from the following description of the preferred embodiments, taken in conjunction with the accompany drawings of which:

FIG. 1 is a control block diagram of a network system according to an aspect of the present invention;

FIG. 2 illustrates a configuration of a network system according to an aspect of the present invention;

FIG. 3 illustrates a configuration of a network system according to another aspect of the present invention;

FIG. 4 is a control block diagram of a computer according to an aspect of the present invention; and

FIG. 5 is a control flow diagram of the computer according to an aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

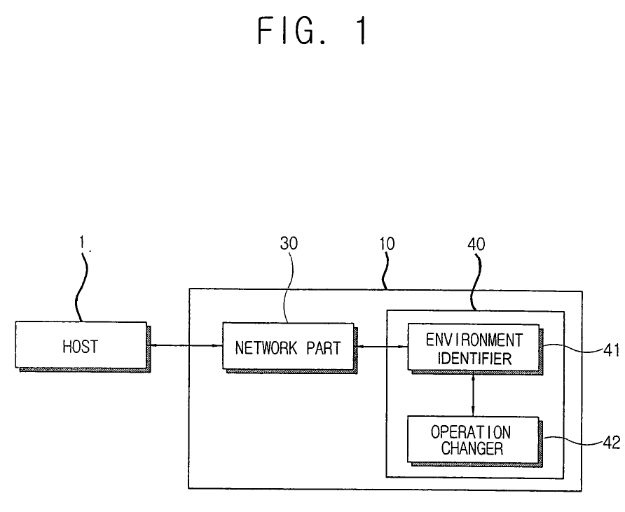

FIG. 1 is a control block diagram of a network system according to an aspect of the present invention. As shown therein, the network system comprises: a computer 10, and a host 1 to which the computer 10 is connected.

The computer 10 according to an aspect of the present invention comprises: a network part 30 to process data exchanged through a network, and a controller 40 to detect an environment identification data from the data received through the network part 30, and to change an operation of the system into a predetermined operation corresponding to the detected environment identification data. Herein, the computer 10 is connected to the host 1 through the network.

The host 1 according to an aspect of the present invention exchanges data with the computer 10 connected through the network, and relays the exchange of data so that the computer 10 can exchange the data with another network. In addition, the host 1 transmits the environment identification data to the computer 10.

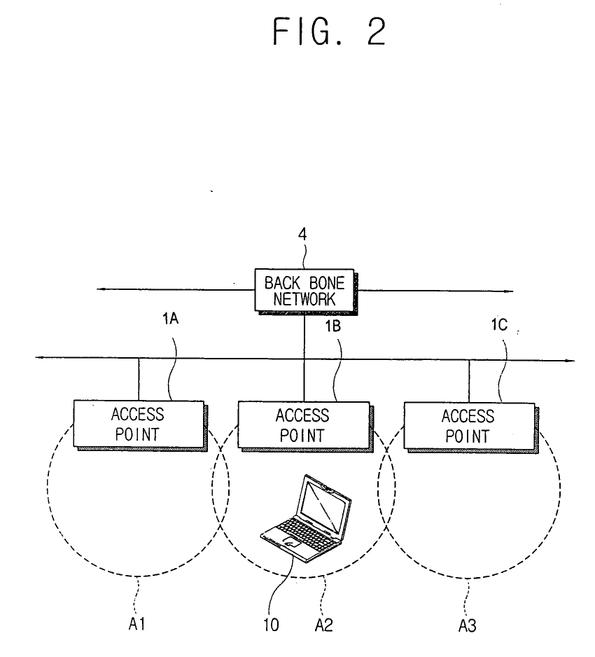

FIG. 2 illustrates a configuration of a network system according to an aspect of the present invention. The host 1 according to an aspect of the present invention comprises: access points 1A, 1B, and 1C. The computer 10 is connected to the access points 1A, 1B, and 1C through a wireless network.

As shown in FIG. 2, the network system according to an aspect of the present invention comprises access points 1A, 1B, and 1C to provide a connection service between wireless LAN service areas A1, A2, and A3 and a wired LAN, and to allow the computer 10 to wirelessly exchange data through the access points 1A, 1B, and 1C.

The access points 1A, 1B, and 1C manage networks within the respective service areas A1, A2, and A3, and are connected to a backbone network 4 to implement a packet relay operation to transfer a packet from a wired LAN to a wireless LAN to support the connection service between the wired LAN and the wireless LAN.

Further, the access points 1A, 1B, and 1C transmit beacon signals in a constant period to notify that the computer 10 is positioned within the respective service area A1, A2, and A3. Herein, the beacon signal includes service set identifier (SSID) data of access points 1A, 1B, and 1C. Generally, the SSID data is a 32-bit text signal. The SSID data is text data inputted to enable providers of the access points 1A, 1B, and 1C to differentiate the respective access points 1A, 1B, and 1C.

The access points 1A, 1B, and 1C wirelessly transmit the environment identification data of the respective service areas A1, A2, and A3 periodically. For example, the environment identification data comprises standardized data for buildings installed with the access points 1A, 1B, and 1C such as a library, a school, a hospital, a theater, etc. According to an aspect of the invention, the environment identification data is included in the SSID data when transmitted. In other words, as the user inputs the environment identification data that will be included in the SSID data for transmission as the standardized text corresponding to respective buildings, the computer 10 receiving the environment identification data identifies an environment or a place within which the access points 1A, 1B, and 1C are installed based on the environment identification data included in the SSID data. For example, “LIB” may be included in the text of the environment identification data in the SSID data of the access points 1A, 1B, and 1C installed in the library to identify the library, or “SCH” and “HOS” may be included in the text of the environment identification data of a school and a hospital, respectively.

According to an aspect of the invention, a recording system of the environment identification data and the SSID data are standardized. In other words, the recording system of the SSID data identified as the text data may be divided into an ID input field where managers of the access points 1A, 1B, and 1C put arbitrary names of the respective access points 1A, 1B, and 1C, a standardized field where the environment identification data is recorded, and a boundary field where a distinguishing symbol is inputted to distinguish the ID input field from the standardized field. For example, the SSID data can be recorded in a form such as “AP1.LIB”. Herein, “AP1” refers to the name of the access points 1A, 1B, and 1C that the user recorded in the ID input field, and “LIB” refers to an environment identification data recorded in the standardized field to represent the library, and the period after the AP1 “.” is the distinguishing symbol recorded in the boundary field to differentiate the access points 1A, 1B, and 1C and the environment identification data. Accordingly, if the computer 10 receives the beacon signal, the data following the boundary field of the SSID data of the beacon signal is identified as the environment identification data.

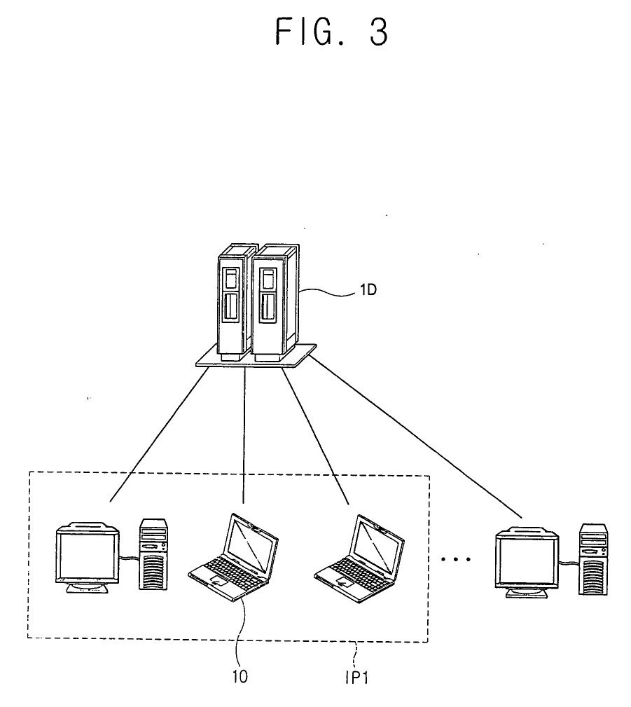

FIG. 3 illustrates a configuration of a network system according to an aspect of the present invention. The host 1 of the network system according to an aspect of the present invention is a server 1D, and the computer 10 is connected to the server 1D through a wired network. As shown in FIG. 3, the network system comprises: the server 1D or the host to manage a computer 10, and the computer 10 connected to the server 1D to exchange the data through the wired network.

The server 1D of the network system according to an aspect of the present invention manages the environment identification data related to the environment of the computer 10 corresponding to each Internet protocol (IP) address using the IP address that the server 1D manages. For example, among the IP addresses that the server 1D manages, the server 1D manages an IP address used in the library separately, and transmits the environment identification data corresponding to the library to the computer 10 connected through the IP address used in the library.

The IP address may be a fixed IP address or a variable IP address. For example, when a fixed IP address is used, the server 1D maintains a list of the fixed IP addresses used in the library. Accordingly, when the computer 10 is connected using the fixed IP address included in the list, the server 1D transmits the environment identification data corresponding to the list to the connected computer 10. However, when a variable IP address is used, the server 1D sets up a variable IP address group IP1 that will be used in the library, and provides the computer 10 connected to the library one of the IP addresses in the variable IP address group IP1. Accordingly, the server 1D can transmit the environment identification data to the computer 10 connected to the library.

Herein, by providing a separate standardized protocol between the server 1D and the computer 10, the computer 10 can detect the environment identification data transmitted from the server 1D. Further, by standardizing an additional field or arbitrary field of a packet of a communication protocol, such as TCP/IP, between the conventional server 1D and the computer 10, the computer 10 identifies the environment identification data.

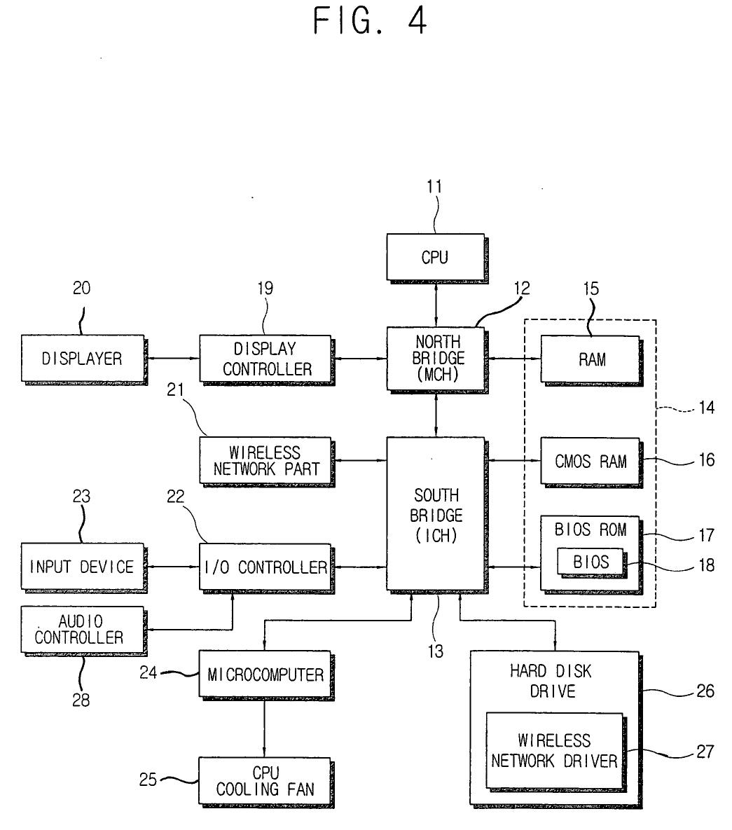

Hereinbelow, the computer 10 will be described with reference to FIG. 4.

As shown in FIG. 4, the computer 10 according to an aspect of the present invention comprises: a central processing unit (CPU) 11, a memory 14, a north bridge 12, a south bridge 13, a plurality of input/output devices (not shown), and a hard disk drive 26. The plurality of input/output devices include, a displayer 20, a display controller 19 to control the displayer 20, an I/O controller 22 to process a signal inputted from an input device 23, such as a key board or a touch pad, and an audio controller 28 to control an audio signal outputted with a speaker.

The memory 14 comprises a random access memory (RAM) 15, which is a non-volatile memory, a BIOS read-only memory (ROM) 17 to store the BIOS 18 which implements a power on self test (POST), and a complementary metal oxide silicon (CMOS) RAM 16.

The north bridge 12 is a chipset such as a memory control hub (MCH) to manage data exchanged among the CPU 11, the RAM 15, and the display controller 19. The south bridge 13 is a chipset such as an I/O control hub (ICH) to manage data exchanged among the I/O controller 22, the BIOS ROM 17, and the CMOS RAM 16.

Further, the computer 10 according to an aspect of the present invention comprises: the network part 30 to process data exchanged through the network, and the controller 40 to detect the environment data from the data received through the network part 30, and to change the operation of the system into a predetermined operation corresponding to the detected environment identification data.

The network part 30 according to another aspect of the present invention comprises: a wireless network part 21 and/or a wired network part (not shown). Herein, the wireless network part 21 is connected to the access points 1A, 1B, and 1C described above and processes the data exchanged wirelessly. The wired network part is wired to the server 1D and processes the data exchanged. FIG. 4 illustrates that the network part 30 is the wireless network part 21 for example, and a corresponding network driver is a wireless network driver.

In addition, the computer 10 according to an aspect of the present invention comprises a database registered with at least one registration data list. Herein, the registration data list is stored with information in relation to a place that requires changing the operation of the system into the predetermined operation. For example, the information is stored in a form such as “*.LIB”, “*.SCH” corresponding to the standardized SSID data as described above. Accordingly, characters following “.” are used in determining whether the database registered contains a detected environment identification data, while a symbol “*” is not used in the determination.

The controller 40 of the computer 10 according to an aspect of the present invention comprises an environment identifier 41 to detect whether the environment identification data is received and whether the detected environment identification data exists on the registration data list. The controller 40 may further comprise an operation changer 42 to change the operation of the system into the predetermined operation corresponding to the environment identification signal when the environment identifier 41 receives the environment identification signal.

The environment identifier 41 according to an aspect of the present invention is a network driver. The network driver is installed and stored in the hard disk drive 26 to control the exchange of the data of the network part 30. The network driver detects the environment identification data from the data received through the network part 30 and detects whether the detected environment identification data exist on the registration data list. Accordingly, when the detected environment identification data exists on the registration data list, the network driver transfers a signal corresponding to the detected environment identification data to the operation changer 42. Meanwhile, the network driver may comprise a wireless network driver 27 and/or a wired network driver (not shown) corresponding to the wireless network part 21 and the wired network part, respectively.

The operation changer 42 according to an aspect of the present invention may be provided in various configurations according to the detected environment identification data.

When the detected environment identification data is the environment identification data corresponding to a quiet place, such as the library, the operation changer 42 according to an aspect of the present invention may comprise a microcomputer 24 and the BIOS 18 stored in the BIOS ROM 17.

Herein, if the environment identification data received from the network driver exists on the registration database, the microcomputer 24 applies a corresponding operation change signal to the CPU 11. According to an aspect of the present invention, the operation change signal is a system management interrupt (SMI) signal.

In addition, the BIOS 18 minimizes load on the CPU 11 by reducing the operating frequency of the CPU 11, when the microcomputer 24 applies the operation change signal to the CPU 11. Accordingly, as an increase in the temperature of the CPU 11 is minimized, operation of the CPU cooling fan 25 is minimized, which decreases noise accompanying the operation of the CPU cooling fan 25 that mainly causes the noise of the computer 10.

Further, the BIOS 18 controls the microcomputer 24 to stop the operation of the CPU cooling fan 25 that cools the CPU 11 or to limit the number of times the CPU cooling fan 25 is operated, when the environment identification data exists on the registration data list and the corresponding signal is received from the network driver. Accordingly, the noise according to the operation of the CPU cooling fan 25 can be reduced or eliminated.

Further, the operation changer 42 according to an aspect of the present invention comprises an audio controller 28. The audio controller 28 implements a function to shut an audio signal outputted from the system, such as a mute function, when the environment identification data corresponding to a quiet place such as the library is received. Accordingly, various sounds generated during the operation of the computer 10 are blocked from being outputted.

According to an aspect of the present invention, the detected environment identification data is the environment identification data corresponding to a dark place, such as a movie theater, and the operation changer 42 may comprise the display controller 19. Accordingly, the display controller 19 regulates the operation of the system in accordance with the environment by controlling a level of brightness of the image displayed on the displayer 20 when the environment identification data corresponding to a dark place is received. Herein, the display controller 19 can control the level of the brightness of the image displayed on the displayer 20 by applying a control signal to the displayer 20, such as the LCD.

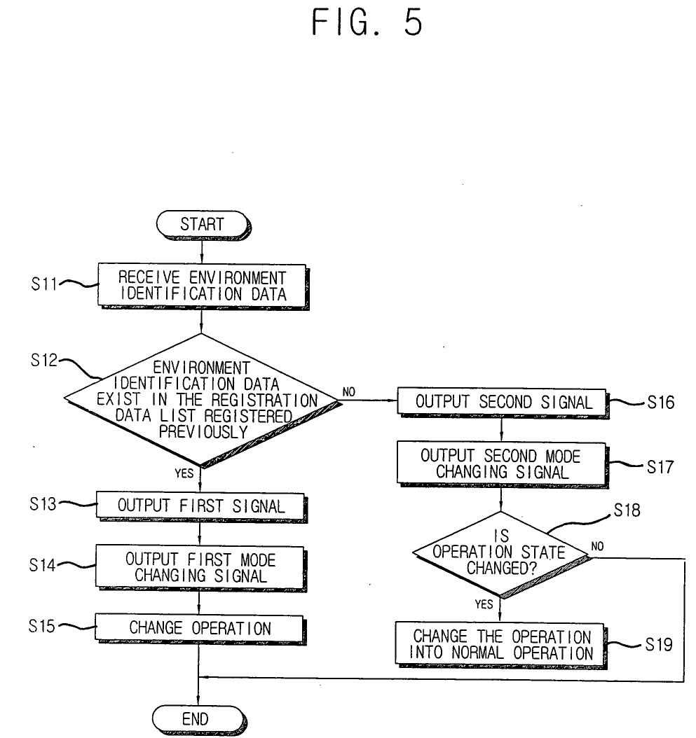

Based on the configuration described above, a control method of the computer 10 according to an aspect of the present invention will be described with reference to FIG. 5. As an illustration, let us assume the computer 10 receives the environment identification data from the access points 1A, 1B, and 1C through the wireless network, and the received environment identification data is the environment identification data corresponding to the quiet place, such as the library.

When a user uses the computer 10 according to an aspect of the present invention in the service areas A1, A2, and A3 of the access points 1A, 1B, and 1C installed in the quiet place, such as the library, the wireless network part 21 receives the SSID data including the environment identification data from the access points 1A, 1B, and 1C at operation S11. The wireless network driver detects the environment identification data from the SSID data, and detects whether the detected environment identification data exists on the registration data list at operation S12. When it is determined that the detected environment identification data exists on the registration data list, the wireless network driver outputs a corresponding first signal to the microcomputer 24 at operation S13.

At operation S14, the microcomputer 24 outputs a first mode change signal to the BIOS 18 upon receipt of the first signal from the wireless network driver. At operation S15, the BIOS 18 controls the microcomputer 24 to reduce the operating frequency of the CPU 11, stop the operation of the CPU cooling fan 25, or limit the number of times the CPU cooling fan 25 is operated, when the first mode change signal is received from the microcomputer 24.

However, when it is determined that the detected environment identification data does not exist on the registration data list at operation S12, the wireless network driver transfers a second signal to the microcomputer 24 at operation S16.

At operation S17, the microcomputer 24 outputs a second mode change signal to the BIOS 18 corresponding to the second signal. Herein, the BIOS 18 detects whether the system is operating in a particular environment at operation S18 upon receipt of the second mode change signal. At operation S19, the BIOS 18 changes the operation of the system into a normal operation, if the system is operating in the particular environment. As an example, the BIOS 18 increases the operating frequency of the CPU 11 to the operating frequency of the normal operation, and releases limitation on the number of times the CPU cooling fan 25 is operated. Meanwhile, the BIOS 18 keeps the normal operation if the system is operating in the normal operation.

Meanwhile, it is preferable that it is determined whether the operation is changed based on the environment identification data received from the access points 1A, 1B, and 1C to which the computer 10 is connected, when the computer 10 according to an aspect the present invention receives the environment identification data from the access points 1A, 1B, and 1C. For example, as shown in FIG. 2, if the computer 10 is positioned in the service, areas A1, A2, and A3 of the plurality of access points 1A, 1B, and 1C, the computer 10 receives the beacon signal from respective access points 1A, 1B, and 1C. Accordingly, it is determined whether the operation should be changed based on the environment identification data transmitted from the substantial access point 1B to which the computer 10 is connected.

According to an aspect of the present invention described above, the SSID data includes the environment identification data transmitted from the access points 1A, 1B, and 1C. However, it may be transmitted as being recorded in an additional field of the beacon signal or it may be transmitted as a separate environment identification data other than the beacon signal using an additional protocol.

Further, according to an aspect of the present invention, the operating frequency of the CPU 11 and the CPU cooling fan 25 are controlled if the computer 10 detects the environment identification data corresponding to the tranquil place. However, it may minimize the noise generated from the computer 10 by controlling an operating frequency of the memory 14 or the display controller 19 and/or by controlling a cooling fan cooling the memory 14 or the display controller 19.

As described above, the operation of the system is changed into the predetermined operation according to the detected environment identification data by providing the network part 30 to process the data received through the network, and the controller 40 to detect the environment identification data from the data received through the network and to change the operation of the system into the operation corresponding to the detected environment identification data.

As described above, the present invention provides a computer, a control method thereof, and a network system to automatically control an operation of the system, for convenience of a user, in accordance the environment where a computer is in use, by changing the operation of the system into the predetermined operation according to the detected environment identification data when the environment identification data received through the network is detected.

Although a few embodiments of the present invention have been shown and described, it will be appreciated by those skilled in the art that changes may be made in these aspects without departing from the principles and spirit of the invention, the scope of which is defined in the appended claims and their equivalents.

1. A computer connected to a network, comprising:
a network part to process data received through the network; and
a controller to detect environment identification data from the data received through the network, and to change an operating state of a system into a predetermined operating state corresponding to the detected environment identification data.

2. The computer according to claim 1, further comprising:
a database registered with at least one registration data list, and
wherein the controller comprises:
an environment identifier to detect whether the environment identification data is received, and to output an environment identification signal corresponding to the detected environment identification data when the detected environment identification data exists in the database; and
an operation changer to change the operating state of the system into a predetermined operating state corresponding to the environment identification signal upon receipt of the environment identification signal from the environment identifier.

3. The computer according to claim 2, wherein the network part comprises:
a wireless network part connected to a wireless network to process the wirelessly exchanged data, and
the environment identification data is included in a beacon signal transmitted from an access point to which the wireless network part is connected, and received through the wireless network.

4. The computer according to claim 3, wherein the environment identification data is included in a service set identifier (SSID) of the beacon signal and transmitted.

5. The computer according to claim 3, wherein the environment identifier is a wireless network driver that controls the wireless network part.

6. The computer according to claim 2, wherein the network part comprises:
a wired network part connected to a wired network and to process data exchanged in wired network, and
the environment identification data is transmitted from a server to which the wired network part is connected.

7. The computer according to claim 3, wherein the operation changer comprises:
a microcomputer to output a change signal corresponding to the environment identification signal upon receipt of the environment identification signal from the environment identifier; and
a basic input/output system to reduce an operation frequency of the system upon receipt of the change signal from the microcomputer.

8. The computer according to claim 7, further comprising:
a cooling fan to cool the system, wherein the basic input/output system controls the microcomputer to stop operation of the cooling fan or limit the frequency of the operation of the cooling fan upon receipt of the change signal from the microcomputer.

9. The computer according to claim 3, wherein the operation changer comprises:
a sound controller to control a sound signal outputted from the system, and to implement a mute function upon receipt of the environment identification signal from the environment identifier.

10. The computer according to claim 3, further comprising:
a displayer to display an image,
a display controller provided to the operation changer, to control a level of brightness of the image displayed on the displayer upon receipt of the environment identification signal from the environment identifier.

11. The computer according to claim 10, wherein the display controller controls the displayer to display information of the environment identification data corresponding to the environment identification signal upon receipt of the environment identification signal from the environment identifier.

12. A network system, comprising:
a computer, comprising:
a network part to process data received from a network, and
a controller to detect environment identification data from the data received through the network, and to change an operating state of a system into a predetermined operating state corresponding to the detected environment identification data; and
a host connected to the computer through the network, to transmit the environment identification data to the computer.

13. The network system according to claim 12, wherein the host comprises:
an access point to which the computer is wirelessly connected.

14. The network system according to claim 13, wherein the access point transmits the environment identification data included in a beacon signal.

15. The network system according to claim 14, wherein the access point transmits the environment identification data included in a service set identifier allocated in the beacon signal.

16. The network system according to claim 12, wherein the host comprises:
a server to which the computer is wired.

17. A control method of a computer connected to a network, comprising:
detecting environment identification data from data received through the network;
detecting whether the detected environment identification data exists in a registration data list previously registered; and
changing an operation of a system into a predetermined operation corresponding to the detected environment identification data when the environment identification data is detected to exist in the registration data list.

18. The control method of the computer according to claim 17, further comprising:
connecting the computer to an access point through a wireless network, wherein detecting whether the detected environment identification data exists in the registration data list includes detecting whether the environment identification data received from the access point to which the computer is connected exists in the registration data list.

19. The control method of the computer according to claim 18, wherein the environment identification data is received included in a beacon signal transmitted from the access point.

20. The control method of the computer according to claim 19, wherein the environment identification data is transmitted included in a service set identifier allocated in the beacon signal.

21. The control method of the computer according to claim 17, further comprising:
connecting the computer to a server through a wired network, wherein detecting whether the detected environment identification data exists in the registration data list includes detecting whether the environment identification data received from the server to which the computer is connected to exists in the registration data list.

22. The control method of the computer according to claim 18, wherein the changing the operation of the system into the predetermined operation corresponding to the detected environment identification data comprises:
reducing an operating frequency of the system.

23. The control method of the computer according to claim 18, wherein the changing the operation of the system into the predetermined operation corresponding to the detected environment identification data comprises:
stopping operation of a cooling fan cooling the system or limiting the frequency of the operation of the cooling fan.

24. The control method of the computer according to claim 18, wherein the changing the operation of the system into the predetermined operation corresponding to the detected environment identification data comprises:
implementing a mute function to limit sound outputted from the system.

25. The control method of the computer according to claim 18, wherein changing the operation of the system into the predetermined operation corresponding to the detected environment identification data comprises:
changing a level of brightness of an image displayed on a displayer that displays the image.

26. The control method of the computer according to claim 21, wherein changing the operation of the system into the predetermined operation corresponding to the detected environment identification data comprises:
changing a level of brightness of an image displayed on a displayer that displays the image.

27. The network system according to claim 16, wherein the server transmits the environment identification data corresponding to an Internet protocol of the computer.

28. A control method of a computer connected to a network, comprising:
receiving an environment identification data descriptive of a location of use of the computer via the network; and
switching an operating state of a system based on the received environment identification data, wherein the environment identification data has a predetermined operating state.

29. The control method of the computer according to claim 28, wherein the environment identification data is included in a beacon signal transmitted from an access point to which the computer is connected.

30. The control method of the computer according to claim 29, wherein the environment identification data is included in a service set identifier of the beacon signal and transmitted to the computer.

31. A control method of a computer connected to a network, the computer having a database to store a registration data list, the method comprising:
determining whether environment identification data received via the network exists in the registration data list; and
automatically changing an operation of a system into a corresponding operation upon determining that the detected environment identification data exists in the registration data list.
